(19) United States
(12) Patent Application Publication
(10) Pub. No.: US 2017/0357855 A1
(43) Pub. Date: Dec. 14, 2017

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Hiroshi KUSUMOTO, Kokubunji-shi (JP)

(21) Appl. No.: 15/614,701

(22) Filed: Jun. 6, 2017

(30) Foreign Application Priority Data
Jun. 10, 2016 (JP) 2016-116222

(51) Int. Cl. G06K 9/00

(52) U.S. Cl. CPC G06K 9/00771; G06K 9/00362

(57) ABSTRACT

In order to facilitate determination as to whether or not a person is a suspicious person, there are provided: a person detecting unit for detecting the person from a captured image captured by one or a plurality of imaging units; a vehicle detecting unit for detecting a vehicle from the captured image; and an associating unit for, in a case where the person detected by the person detecting unit satisfies a predetermined condition of being assumed to be an owner of the vehicle detected by the vehicle detecting unit, associating the detected person with the detected vehicle.

### BACKGROUND OF THE INVENTION

### Field of the Invention

The present invention relates to an information processing apparatus, an information processing method, and a storage medium of storing a program related thereto.

### Description of the Related Art

In recent years, the number and kinds of systems which deliver camera images using networks increases. Such image delivering systems are also adopted for Internet sites which deliver the situations of ski resorts and zoos, surveillance or monitoring in shops, buildings and parking lots, and the like.

Japanese Patent Application Laid-Open No. 2006-11728 discloses the suspicious person countermeasure system. In this system, the data showing the feature of the face of a person is stored together with the attribute showing a secure person or the like, and the relevant person is identified on the basis of the imaged and captured face and the stored feature of the face. Then, it is decided, based on the attribute of the identified person, whether or not to perform a suspicious person countermeasure in regard to the identified person.

However, in such a parking lot as being normally used by unspecified persons, since it is impossible to previously register the features and attributes of persons using the parking lot, there is a problem that it is difficult to determine whether or not a target person is a suspicious person.

### SUMMARY OF THE INVENTION

The present invention has been completed in view of the above problem, and has, for example, the following constitution in order to facilitate determination as to whether or not a target person is a suspicious person.

That is, the present invention comprises a person detecting unit configured to detect a person from a captured image captured by one or a plurality of imaging units, a vehicle detecting unit configured to detect a vehicle from the captured image, and an associating unit configured to, in a case where the person detected by the person detecting unit satisfies a predetermined condition of being assumed to be an owner of the vehicle detected by the vehicle detecting unit, associate the detected person with the detected vehicle.

Further features of the present invention will become apparent from the following description of exemplary embodiments with reference to the attached drawings.

### BRIEF DESCRIPTION OF THE DRAWINGS

FIG. 1 is a general view of a surveillance system.

FIGS. 2A and 2B are diagrams for respectively describing constitutions of an imaging device and a VCA (video content analysis).

FIG. 3 is a diagram for describing the functional constitution of the VCA.

FIGS. 4A and 4B are diagrams for describing an example of data configurations of tables.

FIG. 5 is a flow chart for describing a data registering process.

FIGS. 6A and 6B are explanatory diagrams for describing a process of identifying a stop position of a vehicle.

FIGS. 7A, 7B and 7C are explanatory diagrams of the data registering process.

FIGS. 8A and 8B are explanatory diagrams of the data registering process.

FIGS. 9A, 9B and 9C are explanatory diagrams of another example of a process of identifying a person to be associated.

FIG. 10 is an explanatory diagram of another example of the process of identifying the person to be associated.

FIG. 11 is a flow chart for describing a registration data erasing process.

FIG. 12 is a flow chart for describing a suspicious person detecting process.

FIG. 13 is a diagram for describing an example of a detection area.

FIGS. 14A and 14B are explanatory diagrams of the suspicious person detecting process.

### DESCRIPTION OF THE EMBODIMENTS

Hereinafter, preferred embodiments of the present invention will be described with reference to the accompanying drawings.

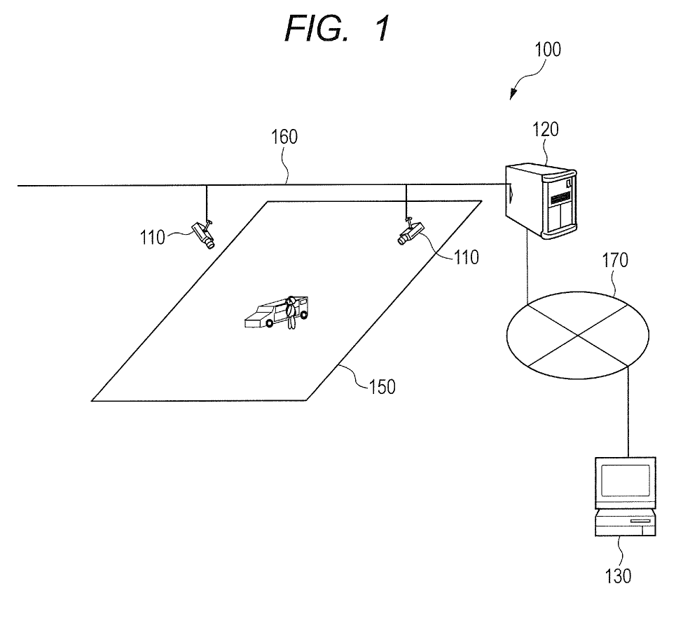

FIG. 1 is a general view of a surveillance (or monitoring) system 100 according to the present embodiment. In the present embodiment, a case where the surveillance system 100 surveils (or monitors) a parking lot 150 will be described as an example. The surveillance system 100 comprises a plurality of imaging devices 110. Each imaging device 110 is a network camera, and is installed in the parking lot 150 as a surveillance area. The installation position, the height and the imaging direction of each imaging device 110 are managed by a later-described VCA (video content analysis) 120. Although the two imaging devices 110 are illustrated in FIG. 1, the number of the imaging devices 110 may be equivalent to one or to three or more.

The imaging device 110 is connected to the VCA 120 via a network 160. Here, it is assumed that the network 160 is a LAN (local area network). A video image captured (imaged) by the imaging device 110 is delivered to the VCA 120 via the LAN 160. The VCA 120 receives the video image from the imaging device 110, analyzes the received video image in the parking lot 150, and thus analyzes suspicious behavior. Besides, the VCA 120 has a function of recording the video image received from the imaging device 110, and a function of delivering data related to the received video image to a terminal device 130 via a network 170. The VCA 120 is an example of an information processing apparatus.

The terminal device 130 is a client terminal of the VCA 120. Although it is assumed that the terminal device 130 is a PC (personal computer) in the present embodiment, a portable terminal device such as a smartphone or the like may be used as another example. The VCA 120 delivers the video image to the terminal device 130, and, when detecting the suspicious behavior from the video image, notifies the terminal device 130 of a suspicious behavior detection. After receiving the notification of the suspicious behavior detection, the terminal device 130 may turn on a search light (not illustrated) installed in the parking lot 150 or issue a warning (alarm).

Incidentally, the imaging device 110 and the VCA 120 in the present embodiment perform communication prescribed by the imaging device 110. Although the LAN 160 and the network 170 are used in the present embodiment, the imaging device 110, the VCA 120 and the terminal device 130 may be connected to a same network. Communication to be performed among the imaging device 110, the VCA 120 and the terminal device 130 is irrespective of its communication standard, communication scale and communication configuration. For example, each of the networks 160 and 170 may be the Internet, a wired LAN, a wireless LAN, a WAN (wide area network), a telephone communication line, or the like. Incidentally, the imaging device 110 according to the present embodiment may correspond to, for example, PoE (Power Over Ethernet (registered trademark)), and, in this case, the imaging device is supplied with electric power via a LAN cable.

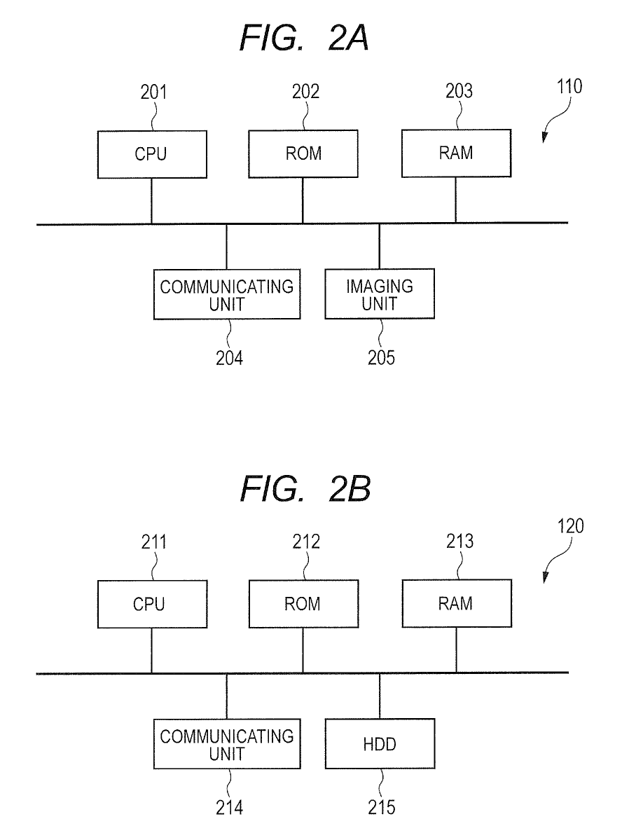

FIG. 2A is a diagram for describing the constitution of the imaging device 110. The imaging device 110 comprises a CPU (central processing unit) 201, a ROM (read only memory) 202, a RAM (random access memory) 203, a communicating unit 204 and an imaging unit 205. The CPU 201 reads control programs stored in the ROM 202, and performs various processes based on the read programs. The RAM 203 is used as temporary storage areas such as a main memory, a working area and the like of the CPU 201. The communicating unit 204 performs a communication process with an external device via a network. The imaging unit 205 captures an image (video image) of the surveillance area. Incidentally, the later-described function and process of the imaging device 110 are realized on the premise that the CPU 201 reads a program stored in the ROM 202 and executes the read program.

FIG. 2B is a diagram for describing the constitution of the VCA 120. The VCA 120 comprises a CPU 211, a ROM 212, a RAM 213, a communicating unit 214 and an HDD (hard disk drive) 215. The CPU 211, the ROM 212, the RAM 213 and the communicating unit 214 are substantially the same as the CPU 201, the ROM 202, the RAM 203 and the communicating unit 204, respectively. The HDD 215 stores various data, various programs and the like. As well as the imaging device 110, the later-described function and process of the VCA 120 are realized on the premise that the CPU 211 reads a program stored in the ROM 212 or the HDD 215 and executes the read program. Incidentally, the hardware constitution of the terminal device 130 is similar to the hardware constitution of the VCA 120. However, it is assumed that the terminal device 130 further comprises a displaying unit and an inputting unit.

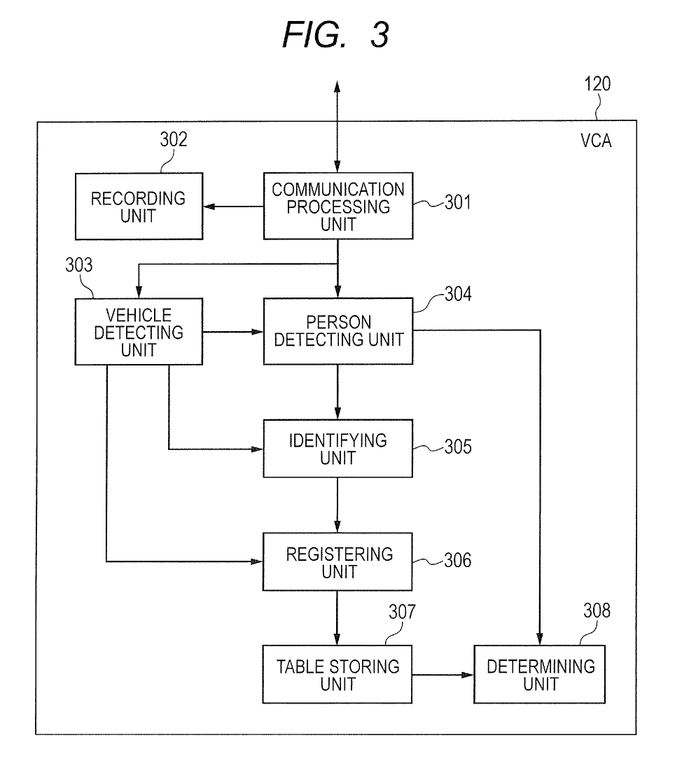

FIG. 3 is a diagram for describing the functional constitution of the VCA 120. The VCA 120 comprises a communication processing unit 301, a recording unit 302, a vehicle detecting unit 303, a person detecting unit 304, an identifying unit 305, a registering unit 306, a table storing unit 307, and a determining unit 308. The communication processing unit 301 controls communication with an external device. For example, the communication processing unit 301 receives a video image as a captured image from the imaging device 110. The communication processing unit 301 also delivers the received video image to the terminal device 130. For example, the recording unit 302 records the video image received by the communication processing unit 301, in a storing unit such as the HDD 215.

The vehicle detecting unit 303 detects a vehicle by applying pattern matching to a moving object in the video image received by the communication processing unit 301. When the vehicle is detected, the vehicle detecting unit 303 gives a vehicle ID to the detected vehicle, and tracks the relevant vehicle. Further, when the vehicle stops, the vehicle detecting unit 303 extracts a feature amount of the vehicle (hereinafter referred to as a vehicle feature amount). For example, the vehicle feature amount includes information of a height of the vehicle, information of a shape of the vehicle in the captured image at the time when the vehicle is stopped, information of a license plate of the vehicle, and the like.

The person detecting unit 304 detects a person by applying pattern matching to a moving object in the video image. For example, the person detecting unit 304 detects the person based on the shape of the person, and the feature of the movement of the person. When the person is detected, the person detecting unit 304 gives a person ID to the detected person, and tracks the relevant person. The person detecting unit 304 further extracts a feature amount of the detected person (hereinafter referred to as a person feature amount). For example, the person feature amount includes a height, a face shape, and the like. Incidentally, the process of detecting the vehicle or the person from the video image is not limited to that described in the embodiment.

The identifying unit 305 identifies, from among the persons detected by the person detecting unit 304, the person to be associated with the vehicle detected by the vehicle detecting unit 303. In the present embodiment, the identifying unit 305 identifies the person who has gotten off the vehicle when the relevant vehicle was stopped in the parking lot 150 as the person to be associated with the vehicle. When the vehicle detected by the vehicle detecting unit 303 stops at the parking lot 150, the registering unit 306 registers the stopped vehicle in the table storing unit 307 as a registration vehicle (or a registered vehicle). As just described, the vehicle which exists in the imaging area by the imaging device 110 is registered as the registration vehicle. Further, the person identified as the person to be associated with the registration vehicle is made correspondent (or is associated) with the registration vehicle, as an association person. The registering unit 306 registers the associated association person and registration vehicle in the table storing unit 307. The determining unit 308 surveils the person detected by the person detecting unit 304 as the surveillance target, and determines whether or not the detected person is a suspicious person.

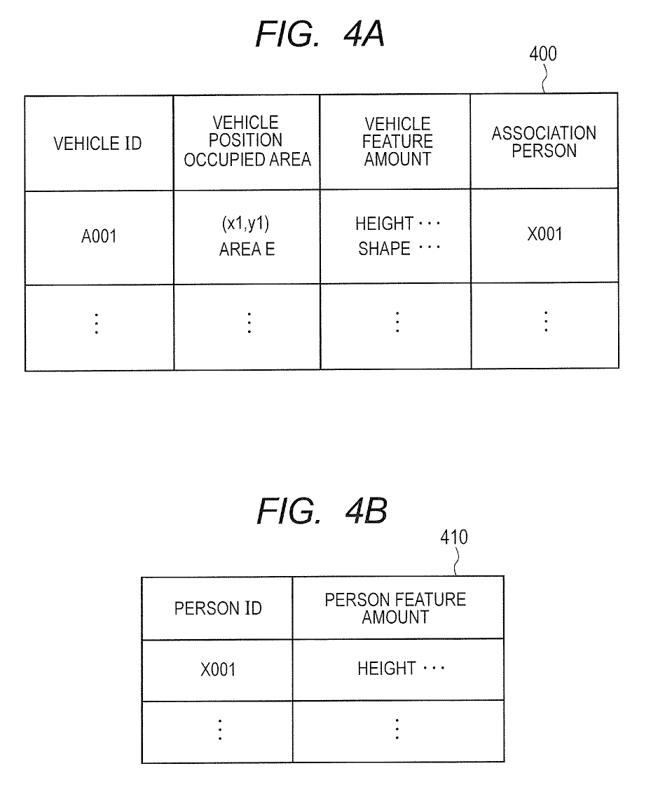

FIGS. 4A and 4B are diagrams for describing an example of data configurations of tables stored in the table storing unit 307. That is, the table storing unit 307 stores therein a registration vehicle table 400 of FIG. 4A and a detection person table 410 of FIG. 4B.

The registration vehicle table 400 is used to store the information related to the registration vehicles. More specifically, the registration vehicle table 400 is used to store the vehicle ID of the registration vehicle, the vehicle position, the occupied area, the vehicle feature amount and the association person, while making them correspondent with others. The vehicle position is the position in the real space estimated from the position of the vehicle in the captured image. The occupied area is the information for identifying the area occupied by the vehicle based on the vehicle position. The vehicle feature amount is the vehicle feature amount extracted by the vehicle detecting unit 303 with respect to the registration vehicle. The association person is the person ID of the person identified as the person to be associated with the registration vehicle by the identifying unit 305.

The detection person table 410 is used to store the information related to the person detected by the person detecting unit 304. More specifically, the detection person table 410 is used to store the person ID and the person feature amount, while making them correspondent with each other. That is, the person feature amount of the association person is made correspondent with the registration vehicle by the person ID of the association person of the registration vehicle table 400 and the person ID of the detection person table 410.

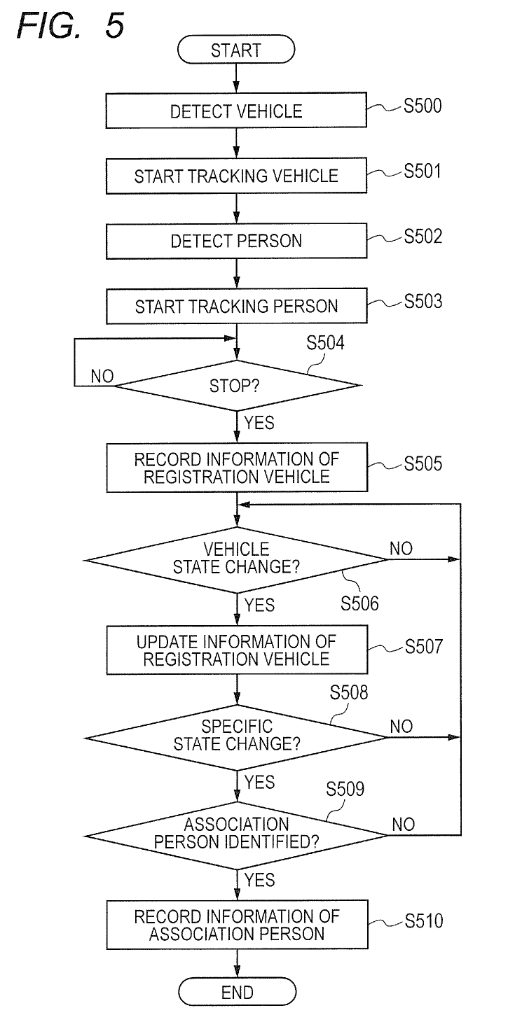

The surveillance system 100 first registers the registration vehicle and the association person in the table storing unit 307, as a preprocess of detecting a suspicious person. FIG. 5 is a flow chart for describing a data registering process in regard to the table storing unit 307. The data registering process is a process of registering, when the vehicle included in the video image as the captured image stops, the stopped vehicle as the registration vehicle. When a plurality of vehicles are included in the video image, the surveillance system 100 performs the data registering process to each of the vehicle as the processing target. For example, when two vehicles A and B (not illustrated) are included in the video image, the surveillance system 100 parallelly performs the data registering process to each of the vehicles A and B as the processing targets.

In S500, the vehicle detecting unit 303 detects one vehicle to be processed from the video image as the captured image. Next, in S501, the vehicle detecting unit 303 gives the vehicle ID to the detected one vehicle, and starts tracking the detected vehicle. Next, in S502, the person detecting unit 304 detects a person from the video image. Next, in S503, the identifying unit 305 gives the person IDs to all the detected persons respectively, and starts tracking all the detected persons.

Next, in S504, the vehicle detecting unit 303 confirms whether or not the tracked vehicle stops. When the vehicle stops (YES in S504), the vehicle detecting unit 303 advances the process to S505. On the other hand, when the vehicle does not stop (NO in S504), the vehicle detecting unit 303 continues the tracking. In tracking of the vehicle, if it is necessary to perform the tracking up to an area outside the parking lot 150, it is assumed that an area with a possibility of the tracking is included in the imaging range of the imaging device 110.

In S505, the vehicle detecting unit 303 records the information of the registration vehicle in the registration vehicle table 400 with the vehicle as the registration vehicle. More specifically, the vehicle detecting unit 303 first identifies the stop position (vehicle position) and the occupied area of the vehicle. Further, the vehicle detecting unit 303 extracts the height of the vehicle, the shape of the vehicle shown in the captured image of the stopped vehicle, and the license plate information such as numbers, letters, symbols and the like shown on the license plate, as the vehicle feature amount. Then, the vehicle detecting unit 303 records (registers) the stop position, the occupied area and the image feature amount of the vehicle, in the registration vehicle table 400.

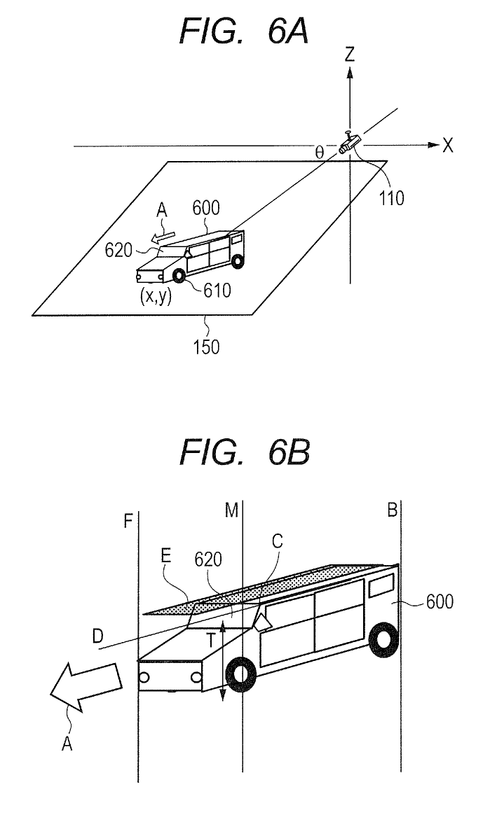

FIGS. 6A and 6B are explanatory diagrams for describing a process of identifying the stop position of the vehicle by the vehicle detecting unit 303. Here, the vehicle detecting unit 303 obtains the position (x, y) in the plane of the parking lot 150, as the stop position of the vehicle. The vehicle detecting unit 303 detects a tire 610 and a windshield 620 of a vehicle 600 on the video image illustrated in FIG. 6A, by pattern matching. Then, the vehicle detecting unit 303 obtains the position of the lower part of the tire 610. Since the tire 610 is in contact with the parking lot 150, it is possible to calculate the distance between the position in the parking lot 150 and the imaging device 110. The vehicle detecting unit 303 further obtains a traveling direction A of the vehicle 600 based on moving body analysis.

Further, as illustrated in FIG. 6B, the vehicle detecting unit 303 detects the intersection between a line D connecting a corner C of the windshield 620 of the vehicle closer to the imaging device 110 and the traveling direction A and a line M extended vertically from the lower position of the tire 610. Then, the vehicle detecting unit 303 obtains a height T of the vehicle 600 on the video image, based on the distance on the video image from the imaging device 110 to the detected intersection. Thus, it can be understood that the imaging magnification of the vehicle 500 is calculated from the distance from the lower position of the tire 610 in the video image to the imaging device 110, and that the vehicle is captured at an angle θ (not illustrated) with respect to the imaging device 110. Thus, it is possible to calculate an approximate value of the actual height of the vehicle.

The vehicle detecting unit 303 further calculates an approximate value of an occupied area E of the vehicle based on the traveling direction A of the vehicle 600, and a front end F and a rear end B of the vehicle 600. Thus, it is possible to calculate the position (X, y) of the vehicle 600 in the parking lot 150 from the occupied area E more accurately. There is a case where the vehicle 600 is hidden (or shadowed) by another vehicle. However, even in this case, it is possible to accurately identify the stop position and occupied area of the vehicle, by performing analysis from the traveling direction A of the vehicle 600, the shape of the windshield, and the like. Besides, by installing some of the imaging devices 110 at an upper elevation of the parking lot 150, the position of the moving body detected as the vehicle is directly reflected on the position on the video image. In this case, the vehicle detecting unit 303 may identify this position as the stop position of the vehicle.

Returning to FIG. 5, after the process of S505, the CPU 201 advances the process to S506. In S506, the vehicle detecting unit 303 confirms whether or not there is a state change of the vehicle (vehicle state change). Here, the state change is a change in the stop position of the vehicle, a change in the shape of the vehicle, or the like. The vehicle detecting unit 303 waits until the state change is confirmed (NO in S506). Then, when the state change is confirmed (YES in S506), the CPU advances the process to S507. In S507, the vehicle detecting unit 303 updates the information of the registration vehicle registered in the registration vehicle table 400, according to the state change. For example, when the registration vehicle temporarily stops, moves again, and then stops again, the vehicle detecting unit 303 updates the vehicle position of the registration vehicle in the registration vehicle table 400.

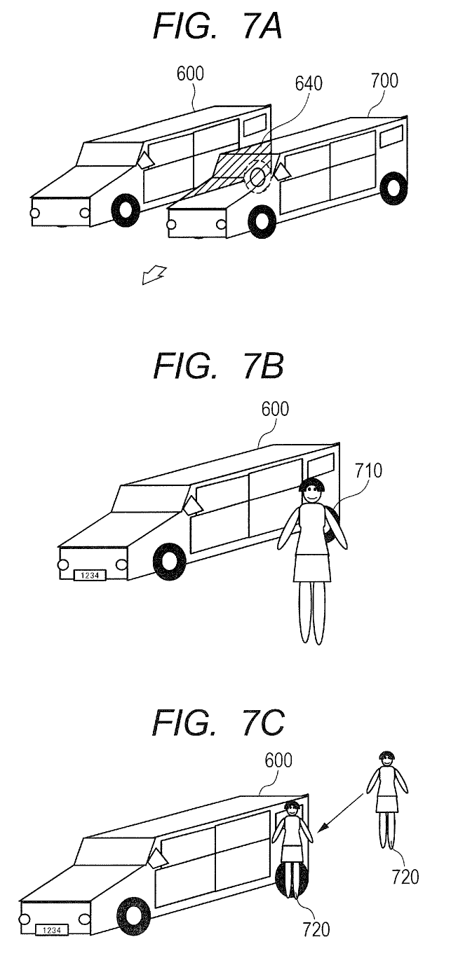

FIGS. 7A to 7C are explanatory diagrams of the data registering process in S506 and S507. After the entire shape of the registration vehicle 600 of FIG. 6B is registered as the shape of the registration vehicle in S505, as illustrated in FIG. 7A, it is assumed that another (or the other) vehicle 700 stops at the position in front of the registration vehicle 600 as viewed from the imaging device 110. In this case, a partial area 640 of the registration vehicle 600 is hidden by the other vehicle 700. Therefore, the shape of the registration vehicle 600 becomes the shape of the area obtained by excluding the partial area 640 from the entire shape of the registration vehicle 600 illustrated in FIG. 6B. In this case, the vehicle detecting unit 303 updates the shape of the registration vehicle 600 in the registration vehicle table 400, that is, the entire area of the registration vehicle 600 is updated to the shape of the area obtained by excluding the area 640 from the entire area.

Thereafter, when the other vehicle 700 moves forward, the overlap between the other vehicle 700 and the registration vehicle 600 increases, so that the shape of the registration vehicle 600 further changes. As just described, every time the shape of the registration vehicle 600 changes, the vehicle detecting unit 303 updates the registered contents of the registration vehicle table 400 in S507. Incidentally, the vehicle detecting unit 303 can identify the partial area 640 in the registration vehicle 600 by detecting the partial area 640 as another moving body (the other vehicle 700).

When the plurality of vehicles are detected like this, the surveillance system 100 performs the data registering process for each of the detected vehicles as the processing target (registration vehicle). That is, the data registering process for the other vehicle 700 is also performed in parallel. Then, when the stop position of the other vehicle 700 is changed, the vehicle detecting unit 303 updates the vehicle position for the other vehicle 700.

Further, as illustrated in FIG. 7B, it is assumed that the person 710 exists at the position in front of the registration vehicle 600 as viewed from the imaging device 110 when the registration vehicle 600 stops. In this case, the shape of the registration vehicle 600 is the shape of the area obtained by excluding the area of a person 710 from the entire shape of the registration vehicle 600 illustrated in FIG. 6B. Therefore, in S504, the vehicle detecting unit 303 registers the relevant shape in the registration vehicle table 400 as the shape of the registration vehicle 600. Thereafter, when the person 710 moves and thus disappears from the front position of the registration vehicle 600 and the entire registration vehicle 600 is displayed on the video image, in S507, the vehicle detecting unit 303 updates the shape of the registration vehicle 600 to the entire shape thereof. At this time, the person detecting unit 304 detects the person 710 in response to an instruction from the vehicle detecting unit 303, and registers the person ID and the like of the detected person in the detection person table 410.

Besides, as illustrated in FIG. 7C, there is a case where a person 720 detected outside the area of the registration vehicle 600 moves into the area of the registration vehicle 600 after the registration vehicle 600 stops. In this case, by referring to the tracking result, the vehicle detecting unit 303 updates the information of the registration vehicle, according to the change in the shape of the registration vehicle 600 caused by the movement of the person 720 from the outside of the registration vehicle 600.

Incidentally, when identifying the shape of the vehicle from the video images obtained by the plurality of imaging devices 110, it is preferable to perform the imaging from the respective positions at which the respective imaging devices 110 face each other. Thus, it is possible to grasp the states of the vehicle in the two directions, and it is thereby possible to improve accuracy in case of identifying the person who gets off the vehicle, as described later.

Returning to FIG. 5, after the process of S507, the CPU 201 advances the process to S508. In S508, the vehicle detecting unit 303 confirms whether or not the state change detected in S505 is a specific state change. Here, the specific state change is a state change which results from the getting-off of the person from the vehicle. In the present embodiment, in correspondence with a fact that the door of the vehicle is opened before the person gets off, it is assumed that the shape change inside the area of the registration vehicle 600 is previously determined as the specific state change. When it is confirmed that the detected state change is the specific state change (YES in S508), the vehicle detecting unit 303 advances the process to S509. On the other hand, when it is confirmed that the detected state change is not the specific state change (NO in S508), the vehicle detecting unit 303 returns the process to S506.

In S509, the identifying unit 305 identifies, from among the persons detected by the person detecting unit 304, the person who has gotten off the registration vehicle, that is, the person (association person) to be associated with the registration vehicle. When the detection position of the detected person satisfies the condition of being the position within the area where the registration vehicle is shown, the identifying unit 305 identifies the detected person as the person to be associated with the registration vehicle. This process is an example of an identifying process of identifying the person to be associated with the registration vehicle, based on a predetermined condition. Incidentally, the identifying unit 305 may identify a plurality of persons as the persons to be associated with one registration vehicle. When identifying the person to be associated with the registration vehicle (YES in S509), the identifying unit 305 advances the process to S510. On the other hand, when failing to identify the person to be associated with the registration vehicle (NO in S509), the identifying unit 305 returns the process to S506.

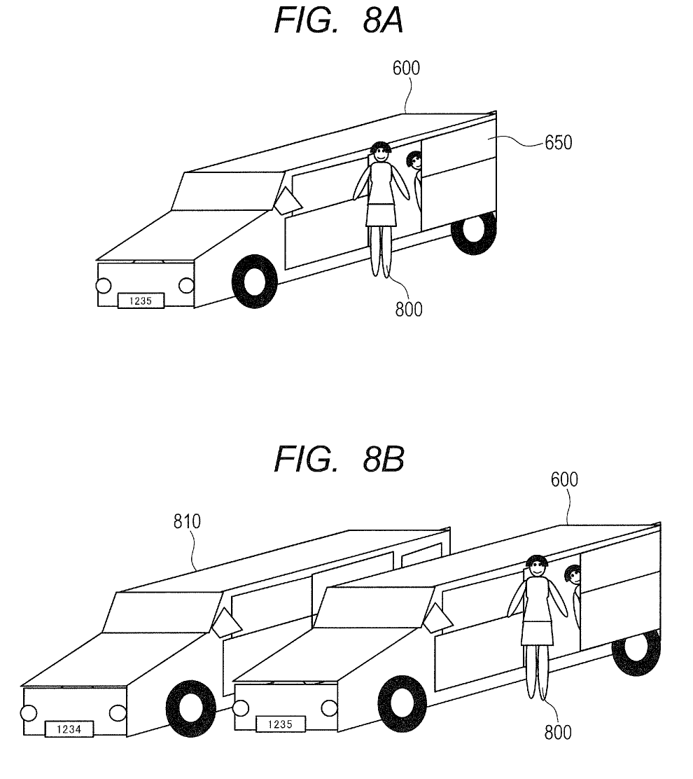

FIGS. 8A and 8B are explanatory diagrams of the data registering process in S508 and S509. As illustrated in FIG. 8A, it is assumed that a door 650 of the registration vehicle 600 is opened. In this case, in S508, the vehicle detecting unit 303 determines that the specific state change occurs, and the identifying unit 305 attempts to identify the person who gets off the registration vehicle, that is, the person to be associated with the registration vehicle. In the example illustrated in FIG. 8A, since the detection position of a person 800 is the position within the area where the registration vehicle 600 is shown, the identifying unit 305 identifies the person 800 as the person to be associated with the registration vehicle 600. This process is an example of a process of identifying the person detected in the area overlapping the area where the vehicle is detected, as the person to be associated with the registration vehicle. Incidentally, it is assumed that the change in the shape of the registration vehicle as described with reference to FIGS. 7A to 7C does not correspond to the specific state change.

As illustrated in FIG. 8B, there is a case where another vehicle 810 overlaps the registration vehicle 600. Even in this case, the vehicle which causes the change in the shape due to the opening of the door is only the registration vehicle 600. Therefore, the identifying unit 305 can identify the person 800 as the person who gets off the registration vehicle 600, not the vehicle 810. Namely, the identifying unit 305 can identify the person 800 as the person associated only with the registered vehicle 600. As just described, since the identifying unit 305 considers the change in the shape, it is possible to accurately identify which of the other vehicle 810 and the registration vehicle 600 the person 800 should be associate with. Incidentally, when the degree of overlap is lower than a threshold value, it may be possible to determine that the registration vehicle does not overlap another vehicle.

Returning to FIG. 5, in S510, the person detecting unit 304 extracts the person feature amount of the person identified as the person to be associated. For example, the person detecting unit 304 extracts the height of the person or the face of the person as the image feature amount. Here, the method of identifying the height is similar to the method of identifying the height of the vehicle as described with reference to FIG. 6B. Incidentally, it is possible to use a face authentication technique or the like in regard to the face of the person. Besides, if the face or the height cannot be identified because the person faces down or bends down, the person detecting unit periodically attempts to extract the feature until the feature can be extracted, by tracking the person associated. In a case where the person feature amount is extracted from the video images from the multiple directions of the plurality of imaging devices, it is possible to shorten the tracking period.

Then, the registering unit 306 records (registers) the person ID of the person to be associated and the person feature amount while making them correspondent with each other, in the detection person table 410. The registering unit 306 further records (registers) the person ID of the person identified as the person to be associated in the column of the association person, while making it correspondent with the vehicle ID of the registration vehicle in the registration vehicle table 400. Thus, the data registering process is completed. In a case where the plurality of persons to be associated are identified, the person ID of each of the plurality of identified persons is registered in the column of the association person. Also, there is a case where one person is identified as the person to be associated with the plurality of registration vehicles. In this case, the person ID of the same person is registered as the person ID of the association person, while making it correspondent with each of the plurality of registration vehicles.

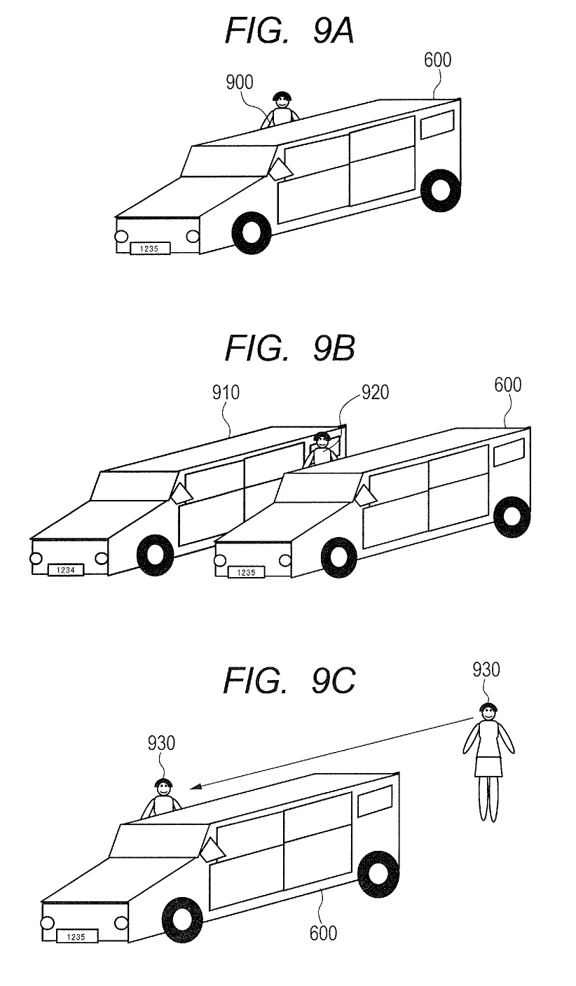

Incidentally, the process of identifying the person to be associated is not limited to that described in the embodiment. As another example, the identifying unit 305 may identify the person detected in the vehicle area based on the position of the registration vehicle as the person to be associated with the registration vehicle. In the present embodiment, it is assumed that the vehicle area is equivalent to a predetermined distance range from the occupied area of the registration vehicle. In this case, for example, in an example of FIG. 9A, a person 900 detected in the vehicle area is identified as the person to be associated with the registration vehicle 600. In an example of FIG. 9B, a person 920 detected at the position overlapping the vehicle areas of both the registration vehicle 600 and the other vehicle 910 is registered as the person to be associated with both the registration vehicle 600 and the other vehicle 910.

In the example of FIG. 9A, it is conceivable that the person 900 moves from the outside of the vehicle area of the registration vehicle 600 to the inside of the vehicle area, and further moves to the outside of the vehicle area. Correspondingly, when the person 900 is detected in the vehicle area, the identifying unit 305 confirms the before-identification movement trajectory of the person 900 which is detected by the person detecting unit 304. Then, when the person 900 is the person who has moved from outside the vehicle area, the identifying unit 305 does not identify the person 900 as a person to be associated with the registration vehicle 600. Thus, it is possible to prevent an erroneous determination that a person who is moving in the vehicle area of the registration vehicle 600 is a person who has gotten off the registration vehicle 600.

Further, as illustrated in FIG. 9C, there is a case where a person 930 moves from the outside of the vehicle area and once disappears from the video image because of hidden by the registration vehicle 600, and the same person 930 again appears in the vehicle area. In this case, the person detecting unit 304 estimates that the person once disappearing and the person again appearing are the same person on the basis of the face authentication or the like, and thus does not give a new person ID. Then, the identifying unit 305 does not identify the person 930 as a person to be associated with the registration vehicle 600.

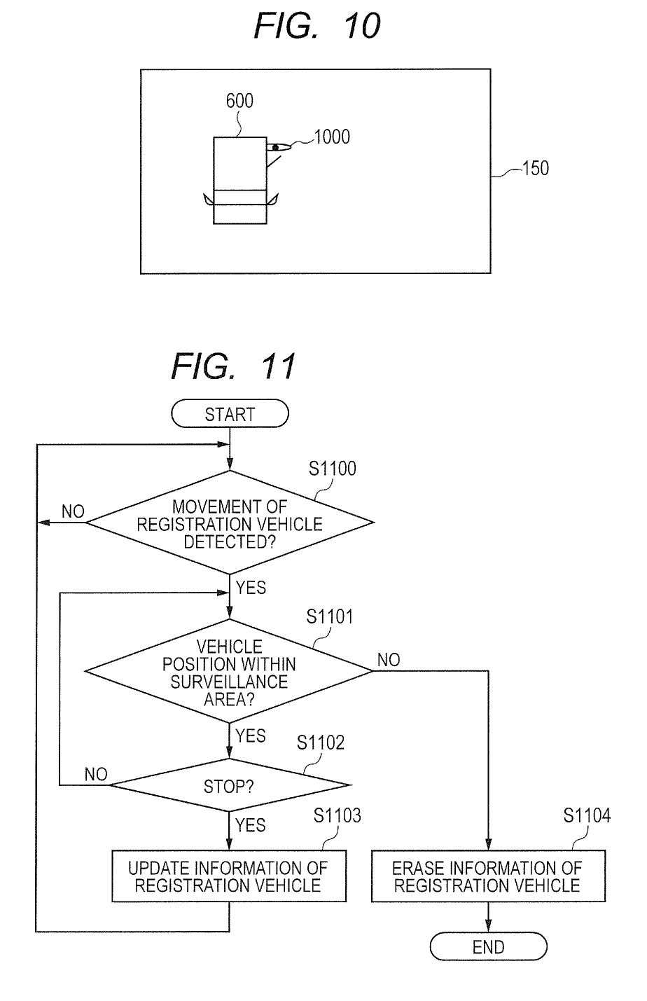

As another example, as illustrated in FIG. 10, it is assumed that, in a case where a person 1000 is detected from the video image captured by the imaging device 110 placed above, the moving object 1000 which is separated from the registration vehicle 600 is detected. In this case, the moving object 1000 may be identified as a person to be associated. As just described, the method of identifying the person to be associated may be determined according to the layout or disposition of the imaging device 110 in the parking lot 150. In addition, when the process of identifying a person to be associated is performed from the video images of the plurality of imaging devices 110 in different imaging directions, it is possible to more accurately identify the relevant person (the person to be associated).

FIG. 11 is a flow chart for describing a registration data erasing process. The registration data erasing process is a process for erasing the data related to the registration vehicle from the table storing unit 307, when the registration vehicle moves outside the surveillance area. In a case where a plurality of registration vehicles are registered in the registration vehicle table 400, the surveillance system 100 parallelly performs the registration data erasing processes for each of the registration vehicles registered in the registration vehicle table 400 as the processing target.

In S1100, the vehicle detecting unit 303 surveilles or monitors whether or not the movement of the registration vehicle registered in the registration vehicle table 400 is detected. The vehicle detecting unit 303 waits until the movement is detected (NO in S1100), and, when the movement is detected (YES in S1100), advances the process to S1101. In S1101, the vehicle detecting unit 303 confirms the vehicle position after the movement. When the vehicle position after the movement is within the surveillance area (YES in S1101), the vehicle detecting unit 303 advances the process to S1102. On the other hand, when the vehicle position after the movement is outside the surveillance area (the parking lot 150) (NO in S1101), the vehicle detecting unit 303 advances the process to S1104.

In S1102, the vehicle detecting unit 303 confirms whether or not the registration vehicle stops. When the registration vehicle stops (YES in S1102), the vehicle detecting unit 303 advances the process to S1103. On the other hand, when the registration vehicle does not stop, that is, when the vehicle is moving (NO in S1102), the vehicle detecting unit 303 returns the process to S1101 to continue the tracking. In S1103, the registering unit 306 updates the information of the registration vehicle. More specifically, the registering unit 306 updates the information related to the vehicle position, the shape and the like of the registration vehicle in the registration vehicle table 400, in accordance with the state of the registration vehicle after the stop. The registering unit 306 then returns the process to S1100. On the other hand, in S1104, the vehicle detecting unit 303 erases the information related to the registration vehicle to be processed, from the registration vehicle table 400. Thus, the registration data erasing process ends.

As described above, by performing the data registering process and the registration data erasing process, the surveillance system 100 can register the vehicle stopped within the surveillance area and the person associated with the relevant vehicle while making them correspondent with each other.

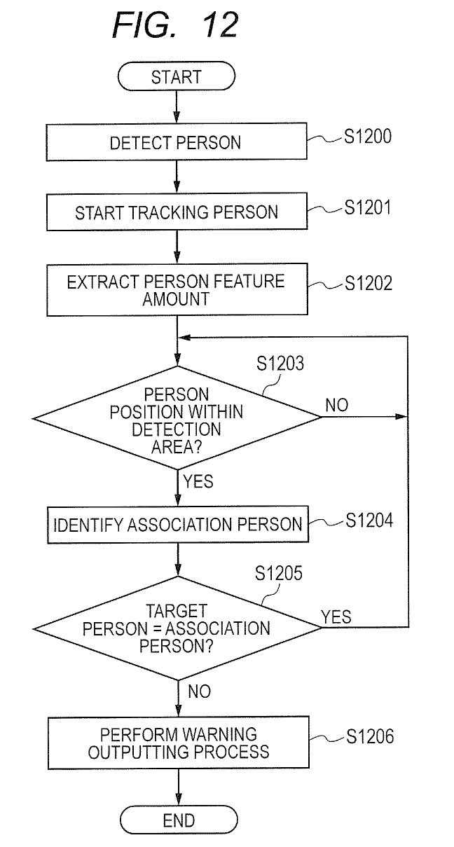

FIG. 12 is a flow chart for describing a suspicious person detecting process. The suspicious person detection process is a process of detecting whether or not the person detected in the surveillance area is a suspicious person. In a case where a plurality of persons are included in the video image, the surveillance system 100 performs the suspicious person detecting process for each of the persons as the processing target. In S1200, the person detecting unit 304 detects a person. The surveillance system 100 performs the subsequent processes to the person detected in S1200, as the determination target. Hereinafter, the person to be detected as the determination target is referred to as a target person. Next, in S1201, the person detecting unit 304 gives an ID to the target person, and starts tracking the target person. Next, in S1202, the person detecting unit 304 extracts the person feature amount of the target person. As described above, the person feature amount to be extracted here is the face, the height and the like of the target person.

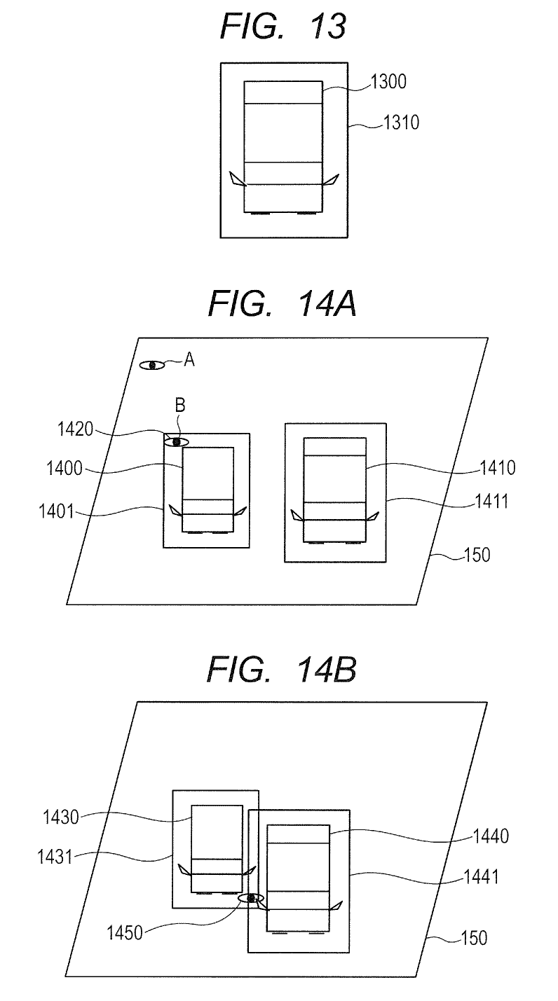

Next, in S1203, the determining unit 308 determines whether or not the position of the target person is within a detection area. Here, the detection area is an area which is based on the position of the registration vehicle. FIG. 13 is a diagram for describing an example of the detection area. In the present embodiment, it is assumed that the range from an occupied area 1300 of the registration vehicle to the position one meter away is a detection area 1310. Incidentally, in the case where the plurality of registration vehicles are registered in the registration vehicle table 400, the detection area is defined for each of the registration vehicles. In a case where the position of the target person is within the detection area of any of the registration vehicles, the determining unit 308 determines that the position of the target person is within the detection area. Incidentally, the detection area may be an area range with based on the position of the registration vehicle, that is, the detection area is not limited to that described the embodiment.

When the position of the target person is within the detection area (YES in S1203), the determining unit 308 advances the process to S1204. On the other hand, when the position of the target person is not within the detection area (NO in S1203), the determining unit 308 again performs the process of S1203. In S1204, the determining unit 308 refers to the registration vehicle table 400, and identifies, based on the correspondence relation between the registration vehicle and the association person, the person associated with the registration vehicle corresponding to the detection area determined to include the position of the target person. As another example, the determining unit 308 may identify the association person from a recognition result of the license plate of the vehicle which is stopping within the detection area determined to include the target person.

Next, in S1205, the determining unit 308 compares the person feature amount of the association person identified in S1204 with the person feature amount of the target person extracted in S1202, thereby determining whether or not the target person is the association person. For example, when a degree of similarity of the person feature amount of the association person and the person feature amount of the target person is equal to or higher than a threshold value, the determining unit 308 determines that the target person is the association person. When it is determined that the target person is the association person (YES in S1205), the determining unit 308 returns the process to S1203. On the other hand, when it is determined that the target person is not the association person (NO in S1205), the determining unit 308 advances the process to S1206.

In S1206, the determining unit 308 controls the communication processing unit 301 to transmit notification information instructing to output (or issue) a warning to the terminal device 130. This process is an example of an output controlling process for controlling to output the warning. When receiving the notification information, the terminal device 130 performs a process of displaying the warning on the displaying unit, outputting a warning sound, or the like. On the other hand, when it is determined that the target person is the association person, the terminal device does not output the warning. That is, when the person who got off the vehicle comes back to the vehicle, the relevant person is not detected as a suspicious person, so that no useless warning is performed.

FIGS. 14A and 14B are explanatory diagrams of the suspicious person detecting process. FIG. 14A is the diagram showing a case where two registration vehicles 1400 and 1410 are stopping. Detection areas 1401 and 1411 are defined for the registration vehicles 1400 and 1410, respectively. In this state, it is assumed that a person 1420 is detected to be located at a position A. The position A is not included in any of the detection areas 1401 and 1411. That is, there is no person who is approaching any of the registration vehicles 1400 and 1410. In this case, NO is given in S1203, and the tracking of the person is continued.

On the other hand, it is assumed that the person 1420 is detected to be located at a position B. The position B is within the detection area 1401. Therefore, it is determined whether or not the person 1420 is the association person of the registration vehicle 1400 corresponding to the detection area 1401 (S1204, S1205). In a case where the person 1420 is the association person of the registration vehicle 1400, a person estimated to have gotten off the registration vehicle 1400 approaches the vehicle. In this case, the determining unit 308 performs control so as to continue the tracking without performing the process of outputting a warning. On the other hand, in a case where the person 1420 is not the association person of the registration vehicle 1400, a person other than the person estimated to have gotten off the registration vehicle 1400 approaches the vehicle. In this case, the determining unit 308 performs the process of outputting a warning.

FIG. 14B is the diagram showing a case where two registration vehicles 1430 and 1440 are stopping and detection areas 1431 and 1441 of the respective registration vehicles 1430 and 1440 overlap each other. In such a state, it is assumed that a person 1450 is detected to be located in the overlapping area of the detection areas 1431 and 1441. In this case, in S1204, the determining unit 308 identifies the association person corresponding to the detection area 1431, and further identifies the association person corresponding to the detection area 1441. Then, in S1205, the determining unit 308 determines whether or not the person 1450 is the association person of the registration vehicle 1430 corresponding to the detection area 1431, and further determines whether or not the person 1450 is the association person of the registration vehicle 1440 corresponding to the detection area 1441.

Then, it is assumed that the person 1450 is determined to be the association person of the registration vehicle 1430 and is determined not to be the association person of the registration vehicle 1440. In this case, a person estimated to have gotten off the registration vehicle 1430 approaches the registration vehicle 1430, and a person other than the person estimated to have gotten off the registration vehicle 1440 approaches the registration vehicle 1440.

Besides, it is assumed that the person 1450 is determined to be the association persons of both the registration vehicles 1430 and 1440. In this case, a person who may have gotten off the registration vehicle 1430 approaches the registration vehicle 1430, and a person who may have gotten off the registration vehicle 1440 approaches the registration vehicle 1440 as well.

As just described, when the person is determined to be the association person made correspondent to the two registration vehicles, it is unknown to which of the vehicles the relevant person corresponds. Therefore, in this case, the determination unit 308 estimates a probability of being the person who has gotten off the registration vehicle to be low as compared with the case where the person is determined to be the association person made correspondent to one registration vehicle. Thus, it is possible to determine a suspicious person more accurately.

As described above, in the surveillance area where unspecified persons are to be surveilled, it is possible for the surveillance system 100 according to the present embodiment to facilitate the determination as to whether or not the person is the suspicious person, without previously registering the feature and the like of the person to be surveilled.

A first modified example of the surveillance system 100 according to the present embodiment will be described. In the present embodiment, the process of outputting the warning is performed when the person other than the association person is located in the detection area. However, in place of this, the process of outputting the warning may be performed only when the person other than the association person continuously stays in the detection area for a certain time. Thus, it is possible to avoid erroneously detecting a person who merely passes through the detection area as the suspicious person.

Also, as a second modified example, the determining unit 308 may control to transmit all of determination results as the notification information to the terminal device 130. In other words, the determining unit 308 may control to transmit information corresponding to the determination result to the terminal device 130. For example, the determining unit 308 may control to transmit information related to a probability that a person is the suspicious person. As just described, the output timing to the terminal device 130 and the kind of output information are not limited to those described in the embodiment.

Although the preferred embodiments of the present invention have been described in detail, the present invention is not limited to the above specific embodiments. Namely, various modifications and changes are possible within the scope of the substance of the present invention described in the claims.

### OTHER EMBODIMENTS

It is possible to achieve the present invention also by supplying a program for realizing one or more of the functions of the above embodiment to a system or an apparatus via a network or a storage medium and causing one or more processors in the computer of the system or the apparatus to read and execute the supplied program. Also, it is possible to achieve the present invention by a circuit (e.g., ASIC) for realizing one or more functions of the above embodiment.

According to each of the embodiments described above, it is possible to facilitate the determination as to whether or not a person is a suspicious person.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-116222, filed Jun. 10, 2016, which is hereby incorporated by reference herein in its entirety.

What is claimed is:

1. An information processing apparatus comprising:
a person detecting unit configured to detect a person from a captured image captured by one or a plurality of imaging units;
a vehicle detecting unit configured to detect a vehicle from the captured image; and
an associating unit configured to, in a case where the person detected by the person detecting unit satisfies a predetermined condition of being assumed to be an owner of the vehicle detected by the vehicle detecting unit, associate the detected person with the detected vehicle.

2. The information processing apparatus according to claim 1, further comprising:
a determining unit configured to, in a case where the person detected by the person detecting unit is positioned in a first range from the vehicle, determine whether or not the detected person is the person associated with the vehicle; and
an output controlling unit configured to control to output notification information according to a determination result by the determining unit.

3. The information processing apparatus according to claim 2, further comprising a storing unit configured to store a registration vehicle previously registered as the vehicle existing in an imaging area of the imaging unit and an association person associated with the registration vehicle, while making the registration vehicle and the association person correspondent with each other,
wherein the determining unit is configured to determine whether or not the detected person is the person associated with a predetermined vehicle, based on a correspondence relation between the registration vehicle and the association person respectively stored in the storing unit.

4. The information processing apparatus according to claim 3, further comprising:
an identifying unit configured to, from among the persons detected by the person detecting unit, identify the person to be associated with the vehicle detected by the vehicle detecting unit, based on a predetermined condition; and
a registering unit configured to register, in the storing unit, the vehicle detected by the vehicle detecting unit and the person identified by the identifying unit respectively as the registration vehicle and the association person, while making the registration vehicle and the association person correspondent with each other.

5. The information processing apparatus according to claim 4, wherein, after a change of a shape of the vehicle is detected, the identifying unit is configured to identify the person detected in an area overlapping an area in which the vehicle is detected, as the person to be associated with the detected vehicle.

6. The information processing apparatus according to claim 4, wherein the identifying unit is configured to identify the person detected in a second range based on a position where the vehicle is detected, as the person to be associated with the detected vehicle.

7. The information processing apparatus according to claim 6, wherein the identifying unit is configured to identify, among the persons detected in the second range, the person other than the person moved from outside the second range, as the person to be associated with the detected vehicle.

8. The information processing apparatus according to claim 4, wherein, in a case where the plurality of persons are identified as the persons to be associated with one vehicle, the registering unit is configured to register the plurality of persons as the association persons while making these persons correspondent with the one registration vehicle.

9. The information processing apparatus according to claim 4, wherein, in a case where the one person is identified as the association person for a plurality of vehicles, the registering unit is configured to register the one person as the association person while making the one person correspondent with the plurality of registration vehicles respectively.

10. The information processing apparatus according to claim 4, wherein the registering unit is configured to register information of a license plate of the detected vehicle while making the information correspondent with the registration vehicle.

11. The information processing apparatus according to claim 4, wherein, in a case where the detected vehicle stops, the registering unit is configured to register a position of the detected vehicle while making the position correspondent with the registration vehicle.

12. The information processing apparatus according to claim 11, wherein the first range includes a range determined by the position of the vehicle.

13. The information processing apparatus according to claim 2, wherein, in a case where the detected person continuously exists for a predetermined time in the first range, the determining unit is configured to determine whether or not the detected person is the person associated with a predetermined vehicle.

14. The information processing apparatus according to claim 2, wherein
in a case where it is determined that the person detected by the person detecting unit is not the person associated with a predetermined vehicle, the output controlling unit is configured to control to output the notification information for notifying a warning, and
in a case where it is determined that the person detected by the person detecting unit is the person associated with the predetermined vehicle, the output controlling unit is configured to control not to output the notification information.

15. An information processing method comprising:
detecting a person from a captured image captured by one or a plurality of imaging units;
detecting a vehicle from the captured image; and
in a case where the detected person satisfies a predetermined condition of being assumed to be an owner of the detected vehicle, associating the detected person with the detected vehicle.

16. A non-transitory computer-readable storage medium of storing a program for causing a computer to function as:
a person detecting unit configured to detect a person from a captured image captured by one or a plurality of imaging units;
a vehicle detecting unit configured to detect a vehicle from the captured image; and
an associating unit configured to, in a case where the person detected by the person detecting unit satisfies a predetermined condition of being assumed to be an owner of the vehicle detected by the vehicle detecting unit, associate the detected person with the detected vehicle.
